(19) United States
(12) Patent Application Publication
(10) Pub. No.: US 2026/0155315 A1
(43) Pub. Date: Jun. 4, 2026

(54) SOLID ELECTROLYTIC CAPACITOR AND SOLID ELECTROLYTIC CAPACITOR PRODUCTION METHOD

(71) Applicant: Panasonic Intellectual Property Management Co., Ltd., Osaka (JP)

(72) Inventors: Saori UEDA, OSAKA FU (JP); Momo KUSAKABE, KYOTO FU (JP); Makoto ONO, FUKUI KEN (JP)

(21) Appl. No.: 19/456,014

(22) Filed: Jan. 22, 2026

Related U.S. Application Data
(63) Continuation of application No. PCT/JP2024/025885, filed on Jul. 19, 2024.

(30) Foreign Application Priority Data
Jul. 26, 2023 (JP) 2023-121571

(51) Int. Cl. H01G 9/08; H01G 9/00; H01G 9/055; H01G 9/15

(52) U.S. Cl. CPC H01G 9/08; H01G 9/0029; H01G 9/055; H01G 9/15

(57) ABSTRACT

A solid electrolytic capacitor includes a laminate in which capacitor elements each including an anode foil, and cathode foils are laminated, an exterior resin covering the laminate and having a first end face on which a part of each anode foil is exposed and a second end face on which a part of each cathode foil is exposed, an anode external electrode electrically connected to each anode foil at the first end face, and a cathode external electrode electrically connected to each cathode foil at the second end face. A first average distance from an end point on the second end face to the respective cathode foils in the lamination direction on the mounting surface side of the exterior resin is smaller than a second average distance from the end point to the respective cathode foils in a region where the capacitor elements and the cathode foils overlap.

### CROSS REFERENCE TO RELATED APPLICATION

The present application is a continuation application of International Application No. PCT/JP2024/025885, filed on Jul. 19, 2024, and claims priority with respect to Japanese Patent Application No. 2023-121571, filed on Jul. 26, 2023. The entire contents of these prior applications are incorporated herein by reference.

### TECHNICAL FIELD

The present disclosure relates to a solid electrolytic capacitor and a solid electrolytic capacitor production method.

### BACKGROUND

Conventionally, electrolytic capacitors (solid electrolytic capacitors) using a solid electrolyte are known. For example, the solid electrolytic capacitor of Japanese Laid-Open Patent Publication No. 2003-86459 includes a laminate in which a plurality of capacitor elements each including an anode foil, and a plurality of cathode foils are laminated, and an exterior resin that covers the laminate. The exterior resin has a first end face on which a part of each anode foil is exposed and a second end face on which another part of each cathode foil is exposed. The solid electrolytic capacitor further includes an anode terminal electrically connected to each anode foil at the first end face, and a cathode terminal electrically connected to each cathode foil at the second end face.

### SUMMARY

The above mentioned solid electrolytic capacitor has been proposed as that having a low equivalent series resistance (ESR), but the ESR is not sufficiently low. Under such circumstances, one of the objects of the present disclosure is to reduce the ESR.

One aspect of the present disclosure relates to a solid electrolytic capacitor. The solid electrolytic capacitor includes: a laminate in which a plurality of capacitor elements each including an anode foil, and a plurality of cathode foils are laminated; an exterior resin that covers the laminate and that has a first end face on which a part of each of the cathode foils is exposed and a second end face on which a part of each of the anode foils is exposed; an anode external electrode electrically connected to each of the anode foils at the first end face; and a cathode external electrode electrically connected to each of the cathode foils at the second end face, wherein a first average distance of the laminate from an end point to the respective the cathode foils in a lamination direction on the second end face on a side of a mounting surface of the exterior resin is smaller than a second average distance from the end point to the respective cathode foils in the lamination direction in a region where the capacitor elements and the cathode foil overlap.

Another aspect of the present disclosure relates to a solid electrolytic capacitor production method. The solid electrolytic capacitor production method is a method for producing the aforementioned solid electrolytic capacitor, including: a preparation step of preparing the laminate; and a forming step of forming the exterior resin by a compression molding method in which a resin material is supplied to the laminate from a side opposite the mounting surface.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic cross-sectional view of an example of a solid electrolytic capacitor according to the present disclosure.

FIG. 2A is a cross-sectional view of a second end face taken along a line A-A in FIG. 1.

FIG. 2B is a cross-sectional view taken along a line B-B in FIG. 1 with capacitor elements omitted.

FIG. 2C is a cross-sectional view of a first end face taken along a line C-C in FIG. 1.

### DETAILED DESCRIPTION

A solid electrolytic capacitor and a solid electrolytic capacitor production method according to the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained.

### Solid Electrolytic Capacitor

The solid electrolytic capacitor according to the present disclosure is a so-called end-face current-collecting solid electrolytic capacitor. The solid electrolytic capacitor according to the present disclosure includes a laminate, an exterior resin, an anode external electrode, and a cathode external electrode. It should be noted that the “exterior resin” as one of the constituent elements of the solid electrolytic capacitor in the present disclosure is not the material itself, and means, for example, a member made of the resin, that is, an “exterior resin member”.

In the laminate, a plurality of capacitor elements and a plurality of cathode foils are laminated. Each of the capacitor elements has an anode foil. Each of the cathode foils may be thinner than the anode foil.

The anode foil may be made of a valving metal such as aluminum, tantalum, niobium, titanium, or an alloy or compound containing any of these valving metals. The surface of the anode foil may be roughened, for example, by etching. A dielectric layer (e.g., a layer of an oxide of a valving metal) is formed on at least a part of the surface of the anode foil, and at least a part of the dielectric layer is covered with a solid electrolyte layer. At least a part of the solid electrolyte layer may be covered with a conductive layer.

The dielectric layer may be made of an oxide (e.g., aluminum oxide) formed on the surface of the anode foil by a liquid phase method such as anodization or a vapor phase method such as vapor deposition or atomic layer deposition.

The solid electrolyte layer may contain a conductive polymer. The solid electrolyte layer may further contain a dopant as necessary.

As the conductive polymer, a known one used for solid electrolytic capacitors, for example, a π-conjugated diene conductive polymer can be used. Examples of the conductive polymer include polymers having a backbone of polypyrrole, polythiophene, polyaniline, polyfuran, polyacetylene, polyphenylene, polyphenylene vinylene, polyacene, or polythiophene vinylene. Among these, a polymer having a backbone of polypyrrole, polythiophene, or polyaniline is preferable. The above polymers also include homopolymers, copolymers of two or more monomers, and derivatives of these (e.g., substituted derivatives). For example, the polythiophene includes poly(3,4-ethylenedioxythiophene). The conductive polymer may be used alone or in combination with two or more kinds thereof.

As the dopant, at least one selected from the group consisting of low molecular anions and polyanions is used, for example. Examples of the low molecular anions include, but are not limited to, sulfate ions, nitrate ions, phosphate ions, borate ions, organic sulfonate ions, and carboxylate ions. Examples of the dopant that produces organic sulfonate ions include benzenesulfonic acid, p-toluenesulfonic acid, and naphthalenesulfonic acid. Examples of the polyanions include polymer-type polysulfonic acids and polymer-type polycarboxylic acids. Examples of the polymer-type polysulfonic acids include polyvinylsulfonic acid, polystyrenesulfonic acid, poly(allylsulfonic acid), poly(acrylsulfonic acid), and poly(methacrylsulfonic acid). Examples of the polymer-type polycarboxylic acids include polyacrylic acids and polymethacrylic acids. The polyanions also include polyester sulfonic acids and phenolsulfonic acid novolac resins, for example. However, the polyanions are not limited thereto.

The solid electrolyte layer may further contain a known additive and a known conductive material other than the conductive polymer, as necessary. Examples of the conductive material as above include at least one selected from the group consisting of conductive inorganic materials such as manganese dioxide, and TCNQ complex salts.

The conductive layer may consist only of a carbon layer formed on the surface of the solid electrolyte layer or may be composed of the carbon layer and a conductive layer formed on the surface of the carbon layer. The conductive layer may be made of a silver paste. For example, a composition containing silver particles and a resin component (binder resin) may be used as the silver paste. As the resin component, a thermoplastic resin can be used, but a thermosetting resin such as an imide-based resin or an epoxy resin is preferably used.

The cathode foil may be made of a metal such as gold, silver, copper, aluminum, or nickel. The surface of the cathode foil may be roughened, for example, by etching and may be additionally coated with carbon or the like. The cathode foil may be connected to the conductive layer, for example, with a conductive adhesive. The conductivity of the material forming the cathode foil may be higher than the conductivity of the material forming the cathode external electrode.

The exterior resin covers the laminate. The exterior resin has a first end face on which a part of each anode foil is exposed, and a second end face on which a part of each cathode foil is exposed. The first end face and the second end face may be opposite to each other. The shape of each of the first end face and the second end face is not particularly limited, and may be, for example, flat or curved, or may have depressions and protrusions at least in part. The exterior resin may be made of an insulative resin material. The exterior resin may be formed of a cured product of a thermosetting resin such as an epoxy resin and may contain a filler as necessary.

The anode external electrode is electrically connected to each anode foil at the first end face of the exterior resin. The anode external electrode may be made of silver, copper, a copper alloy, aluminum, or an aluminum alloy, and may be plated. A plating layer, a conductive adhesive, or the like may or may not be provided between the anode external electrode and each anode foil. The anode external electrode may have a single-layer structure or a multilayer structure. The anode external electrode having a multilayer structure may include, for example, at least one metal layer and at least one plating layer. A part of the anode external electrode may extend along the mounting surface of the exterior resin (mounting surface of the solid electrolytic capacitor).

The cathode external electrode is electrically connected to each cathode foil at the second end face of the exterior resin. The cathode external electrode may be made of silver, copper, a copper alloy, aluminum, or an aluminum alloy, and may be plated. The constituent material of the cathode external electrode may be the same as or different from the constituent material of the anode external electrode. A plating layer, a conductive adhesive, or the like may or may not be provided between the cathode external electrode and each cathode foil. The cathode external electrode may have a single-layer structure or a multilayer structure. The cathode external electrode having a multilayer structure may include, for example, at least one metal layer and at least one plating layer. A part of the cathode external electrode may extend along the mounting surface of the exterior resin (mounting surface of the solid electrolytic capacitor).

The end point on the side of the mounting surface of the second end face of the exterior resin is defined as a “first end point”. The first average distance is smaller than the second average distance. Here, the first average distance is the average of distances of the laminate (e.g., in the direction perpendicular to the mounting surface) from the first end point to the respective cathode foils in the lamination direction along the second end face, and the second average distance is the average of distances from the first end point to the respective cathode foils in the lamination direction in the region where the capacitor elements and the cathode foils overlap (e.g., a region including an intermediate point between the first end face and the second end face, hereinafter, also referred to as overlap region). The average of distances from the first end point to the respective cathode foils in the lamination direction means a value obtained by dividing the sum of the shortest distances from the first end point to the respective cathode foils in the lamination direction by the number of the cathode foils included in the solid electrolytic capacitor.

In the solid electrolytic capacitor according to the present disclosure having the above configuration, the first average distance along the second end face is smaller than the second average distance in the overlap region. That is, on the second end face, which is a face connecting each cathode foil and the cathode external electrode, the plurality of cathode foils as a whole are arranged close to the mounting surface. Therefore, when the solid electrolytic capacitor according to the present disclosure is mounted on a substrate or the like, the sum of the current paths from the wires of the substrate to the respective cathode foils is shorter than, for example, when the solid electrolytic capacitor according to Japanese Laid-Open Patent Publication No. 2003-86459 is mounted on the substrate or the like. Therefore, the ESR of the solid electrolytic capacitor can be reduced. The first average distance is preferably 90% or less of the second average distance, and more preferably 80% or less of the second average distance.

At least cathode foils in one pair adjacent to and spaced apart from each other in the lamination direction are present on the second end face. The at least cathode foils in one pair such as above may be present close to the mounting surface among the plurality of cathode foils. For example, in the case of eight cathode foils, three or more and five or less cathode foils located close to the mounting surface may be spaced apart from each other. According to this configuration, damage of the structure of the laminate by an excessive force acting on the cathode foils in covering the laminate with the exterior resin can be suppressed.

At least anode foils in one pair adjacent to and spaced apart from each other in the lamination direction are present on the first end face. The at least anode foils in one pair such as above may be located close to the mounting surface among the plurality of anode foils. The ratio of the number of the anode foils spaced apart from each other to the total number of the anode foils may be higher than the ratio of the number of the cathode foils spaced apart from each other to the total number of the cathode foils. For example, in the case of seven anode foils, five or more and seven or less anode foils located close to the mounting surface may be apart from each other. According to this configuration, damage of the anode foils by an excessive force acting on the anode foils in covering the laminate with the exterior resin can be suppressed.

The exterior resin may contain a filler. The content of the filler in the exterior resin may be 85 wt% or more and 95 wt% or less. According to this configuration, the physical properties of the exterior resin which are particularly suitable for realizing the configuration of the solid electrolytic capacitor according to the present disclosure can be achieved.

The flexural modulus at 25° C. of the exterior resin may be 20 GPa or more. According to this configuration, the physical properties of the exterior resin which are particularly suitable for realizing the configuration of the solid electrolytic capacitor according to the present disclosure can be achieved.

The glass transition temperature of the exterior resin may be 135° C. or higher. According to this configuration, the physical properties of the exterior resin which are particularly suitable for realizing the configuration of the solid electrolytic capacitor according to the present disclosure can be achieved.

### Solid Electrolytic Capacitor Production Method

A solid electrolytic capacitor production method according to the present disclosure is a method for producing the above-described solid electrolytic capacitor and includes a preparation step and a molding step.

In the preparation step, the laminate is prepared. In the preparation step, for example, the laminate may be prepared by alternately laminating the plurality of anode foils and the plurality of cathode foils.

In the molding step, the exterior resin is formed by a compression molding method in which the resin material is supplied to the laminate from the side opposite the mounting surface. According to the compression molding method, the exterior resin can be filled and molded in a manner, for example, that the resin material in granule form is placed in a mold and then subjected to pressure application while being melted in the process of closing the heated mold. The resin material is supplied to the laminate from the side opposite the mounting surface. Accordingly, the pressure acts on the laminate so as to push it toward the mounting surface. This pressure pushes the area of at least one of the cathode foils near the second end face toward the mounting surface to deform the area, whereby the first average distance becomes shorter than the second average distance. Thus, a solid electrolytic capacitor with low ESR is obtained.

The exterior resin may contain a filler. The content of the filler in the exterior resin may be 85 wt% or more and 95 wt% or less. According to this configuration, the characteristics of the exterior resin which are particularly suitable for realizing the configuration of the solid electrolytic capacitor according to the present disclosure by the above-described compression molding method can be achieved.

The flexural modulus of the exterior resin may be 20 GPa or more at 25° C. According to this configuration, the characteristics of the exterior resin which are particularly suitable for realizing the configuration of the solid electrolytic capacitor according to the present disclosure by the above-described compression molding method can be achieved.

The glass transition temperature of the exterior resin may be 135° C. or higher. According to this configuration, the characteristics of the exterior resin which are particularly suitable for realizing the configuration of the solid electrolytic capacitor according to the present disclosure by the above-described compression molding method can be achieved.

As described above, according to the present disclosure, the ESR of the solid electrolytic capacitor can be reduced by setting the first average distance along the second end face smaller than the second average distance in the overlap region.

The following specifically describes examples of the solid electrolytic capacitor and the solid electrolytic capacitor production method according to the present disclosure with reference to the accompanying drawings. The elements of configuration and the steps described above are applicable to the elements of configuration of the exemplary solid electrolytic capacitor and the steps of the exemplary solid electrolytic capacitor production method, which are described below. The elements of configuration of the exemplary solid electrolytic capacitor and the steps of the exemplary solid electrolytic capacitor production method described below can be altered based on the above description. Further, the matters described below may be applied to the above-described embodiments. Among the elements of configuration of the exemplary solid electrolytic capacitor and the steps of the exemplary solid electrolytic capacitor production method described below, an element of configuration or a step that is not essential to the solid electrolytic capacitor or the solid electrolytic capacitor production method according to the present disclosure may be omitted. It should be noted that the drawings indicated below are schematic and do not accurately reflect the shape or number of actual members.

### Solid Electrolytic Capacitor

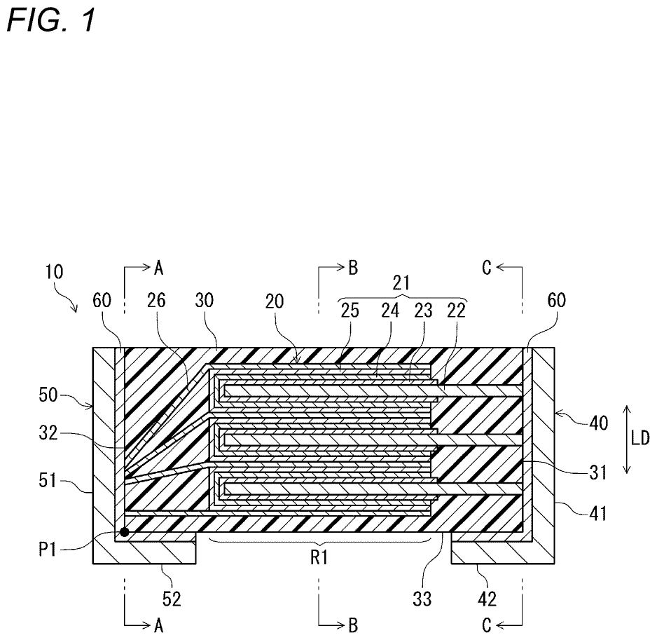

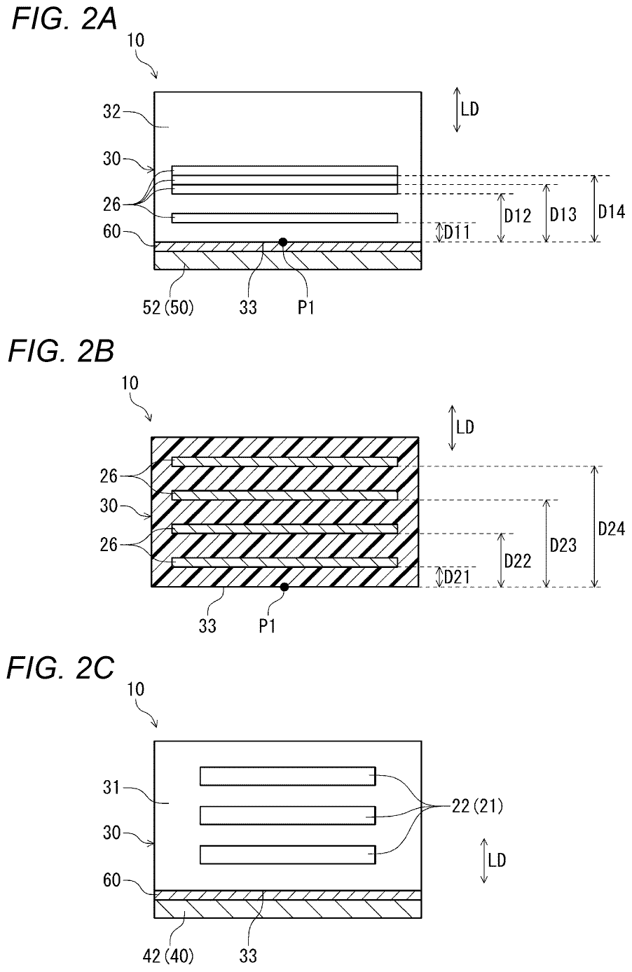

A solid electrolytic capacitor 10 of the present embodiment is a so-called end-face current-collecting solid electrolytic capacitor, and includes a laminate 20, an exterior resin 30, an anode external electrode 40, and a cathode external electrode 50 as illustrated in FIGS. 1 and 2A to 2C.

In the laminate 20, a plurality of (in this example, three) capacitor elements 21 and a plurality of (in this example, four) cathode foils 26 are alternately laminated. Each of the plurality of capacitor elements 21 includes an anode foil 22.

The anode foil 22 of the present embodiment is formed in a rectangular sheet shape, and its surface is roughened. A dielectric layer 23 is formed on at least a part of the surface of the anode foil 22. At least a part of the dielectric layer 23 is covered with a solid electrolyte layer 24. At least a part of the solid electrolyte layer 24 is covered with a conductive layer 25.

Each of the cathode foils 26 in the present embodiment is formed in a rectangular sheet shape, and its surface is roughened. The cathode foil 26 is electrically connected to the conductive layer 25 of the corresponding anode foil 22 via a non-illustrated conductive adhesive. The cathode foil 26 is made of a material having a higher conductivity than the constituent material of the cathode external electrode 50.

The exterior resin 30 covers the laminate 20. The exterior resin 30 has a first end face 31 (an end face on the right side in FIG. 1) on which a part of each anode foil 22 is exposed, and a second end face 32 (an end face on the left side in FIG. 1) on which a part of each cathode foil 26 is exposed. The exterior resin 30 is made of an insulative resin material. The exterior resin 30 contains a filler (not illustrated) in a content of 85 wt% or more and 95 wt% or less. The flexural modulus of the exterior resin 30 at 25° C. is 20 GPa or more, and may be, for example, 20 GPa or more and 35 GPa or less. The glass transition temperature of the exterior resin 30 is 135° C. or higher, and may be, for example, 135° C. or higher and 160° C. or lower.

The anode external electrode 40 is electrically connected to each anode foil 22 at the first end face 31 of the exterior resin 30. In the present embodiment, the anode external electrode 40 is electrically connected to the respective anode foils 22 using a conductive adhesive 60, but the present disclosure is not limited thereto. The anode external electrode 40 has a first portion 41 extending along the first end face 31, and a second portion 42 continuous with the first portion 41 and extending along a mounting surface 33 (lower surface in FIG. 1) of the exterior resin 30.

The cathode external electrode 50 is electrically connected to each cathode foil 26 at the second end face 32 of the exterior resin 30. In the present embodiment, the cathode external electrode 50 is electrically connected to the respective cathode foils 26 using the conductive adhesive 60, but the present disclosure is not limited thereto. The cathode external electrode 50 has a third portion 51 extending along the second end face 32, and a fourth portion 52 continuous with the third portion 51 and extending along the mounting surface 33 of the exterior resin 30.

The end point on the second end face 32 of the exterior resin 30 on the side of the mounting surface 33 of the exterior resin 30 is referred to as a first end point P1. A first average distance AD1 of the distances from the first end point P1 to the respective cathode foils 26 in the lamination direction LD along the second end face 32 is smaller than a second average distance AD2 of the distances from the first end point P1 to the respective cathode foils 26 in the lamination direction LD in an overlap region R1 in which the capacitor elements 21 and the cathode foils 26 overlap. The magnitude relationship between the first average distance AD1 and the second average distance AD2 results from the fact that at least some of the cathode foils 26 become closer to the mounting surface 33 as they extend from the overlap region R1 toward the second end face 32 as illustrated in FIG. 1.

In the present embodiment, the first average distance AD1 is obtained from the equation AD1=(D11+D12+D13+D14)/4 with D11 to D14 defined as the shortest distances from the first end point P1 to the respective cathode foils 26 along the second end face 32 (see FIG. 2A). Similarly, the second average distance AD2 is obtained from the equation AD2=(D21+D22+D23+D24)/4 with D21 to D24 defined as the shortest distances from the first end point P1 to the respective cathode foils 26 in the overlap region R1 (see FIG. 2B). It goes without saying that both equations can be altered as appropriate according to the number of the cathode foils 26. Note that the first end point P1 is indicated in FIG. 2B, which is the first end point P1 projected in the direction (left-right direction in FIG. 1) in which the first end face 31 and the second end face 32 face each other onto the cross-sectional position illustrated in the same figure.

As illustrated in FIG. 2A, at least cathode foils 26 in one pair that are adjacent to and spaced apart from each other in the lamination direction LD are present on the second end face 32. In this example, the pair of cathode foils 26 located on the side of the mounting surface 33 corresponds thereto. As illustrated in FIG. 2C, at least anode foils 22 in one pair that are adjacent to and spaced apart from each other in the lamination direction LD are present on the first end face 31. In this example, all pairs of cathode foils 26 correspond thereto.

### Solid Electrolytic Capacitor Production Method

The solid electrolytic capacitor production method according to the present embodiment is a method for producing the above-described solid electrolytic capacitor 10 and includes a preparation step and a molding step.

In the preparation step, the above-described laminate 20 is prepared. In the preparation step, the laminate 20 is prepared by alternately laminating the plurality of anode foils 22 and the plurality of cathode foils 26.

In the molding step, the exterior resin 30 is formed by a compression molding method in which the resin material is supplied to the laminate 20 from the side (the upper side in FIG. 1) opposite the mounting surface 33. In practice, since the resin material in a molten state is supplied into a predetermined mold, the laminate 20 in the molding step is oriented opposite the orientation indicated in FIG. 1.

### Supplemental Note

According to the above description of the embodiments, the following techniques are disclosed.

### Technique 1

A solid electrolytic capacitor including:
a laminate in which a plurality of capacitor elements each including an anode foil, and a plurality of cathode foils are laminated;
an exterior resin that covers the laminate and that has a first end face on which a part of each of the cathode foils is exposed and a second end face on which a part of each of the anode foils is exposed;
an anode external electrode electrically connected to each of the anode foils at the first end face; and
a cathode external electrode electrically connected to each of the cathode foils at the second end face,
wherein a first average distance of the laminate from an end point to the respective the cathode foils in a lamination direction on the second end face on a side of a mounting surface of the exterior resin is smaller than a second average distance from the end point to the respective cathode foils in the lamination direction in a region where the capacitor elements and the cathode foil overlap.

### Technique 2

The solid electrolytic capacitor according to Technique 1, wherein of the cathode foils, at least cathode foils in one pair are present at the second end face, the at least cathode foils in the one pair being adjacent to and spaced apart from each other in the lamination direction.

### Technique 3

The solid electrolytic capacitor according to Technique 1 or 2, wherein of the anode foils, at least anode foils in one pair are present at the first end face, the at least anode foils in the one pair being adjacent to and spaced apart from each other in the lamination direction.

### Technique 4

The solid electrolytic capacitor according to any one of Techniques 1 to 3, wherein the exterior resin contains a filler, and
a content of the filler in the exterior resin is 85 wt% or more and 95 wt% or less.

### Technique 5

The solid electrolytic capacitor according to any one of Techniques 1 to 4, wherein a flexural modulus of the exterior resin at 25° C. is 20 GPa or more.

### Technique 6

The solid electrolytic capacitor according to any one of Techniques 1 to 5, wherein a glass transition temperature of the exterior resin is 135° C. or higher.

### Technique 7

A method for producing the electrolytic capacitor according to any one of Techniques 1 to 6, the method including:
a preparation step of preparing the laminate; and
a forming step of forming the exterior resin by a compression molding method in which a resin material is supplied to the laminate from a side opposite the mounting surface.

### Technique 8

The solid electrolytic capacitor production method according to Technique 7, wherein the exterior resin contains a filler, and
a content of the filler in the exterior resin is 85 wt% or more and 95 wt% or less.

### Technique 9

The solid electrolytic capacitor production method according to Technique 7 or 8, wherein a flexural modulus of the exterior resin at 25° C. is 20 GPa or more.

### Technique 10

The solid electrolytic capacitor production method according to any one of Techniques 7 to 9, wherein a glass transition temperature of the exterior resin is 135° C. or higher.

### Examples

Each ESR of the solid electrolytic capacitors of Examples 1 and 2 and Comparative Examples 1 and 2 indicated below was evaluated.

### Example 1

Seven capacitor elements and eight cathode foils were alternately laminated to form a laminate. The laminate was covered with an exterior resin. A part of each anode foil was exposed on the first end face of the exterior resin. All the anode foils were spaced apart from each other at the first end face. An anode external electrode was electrically connected to each anode foil at the first end face. A part of each cathode foil was exposed on the second end face of the exterior resin. At the second end face, the four cathode foils located on the side of the mounting surface were separated from each other, while the other four cathode foils were brought into contact with each other. A cathode external electrode was electrically connected to each cathode foil at the second end face. The first average distance along the second end face was set to 76% of the second average distance in the overlap region. The ESR of the solid electrolytic capacitor of Example 1 was 90% of the ESR of a solid electrolytic capacitor of Comparative Example 1.

### Example 2

Seven capacitor elements and eight cathode foils were alternately laminated to form a laminate. The laminate was covered with an exterior resin. A part of each anode foil was exposed on the first end face of the exterior resin. All the anode foils were spaced apart from each other at the first end face. An anode external electrode was electrically connected to each anode foil at the first end face. A part of each cathode foil was exposed on the second end face of the exterior resin. All the cathode foils were brought into contact with each other on the side of the mounting surface at the second end face. A cathode external electrode was electrically connected to each cathode foil at the second end face. The first average distance along the second end face was set to 33% of the second average distance in the overlap region. The ESR of the solid electrolytic capacitor of Example 2 was 78% of the ESR of the solid electrolytic capacitor of Comparative Example 1.

### Comparative Example 1

Seven capacitor elements and eight cathode foils were alternately laminated to form a laminate. The laminate was covered with an exterior resin. A part of each anode foil was exposed on the first end face of the exterior resin. All the anode foils were spaced apart from each other at the first end face. An anode external electrode was electrically connected to each anode foil at the first end face. A part of each cathode foil was exposed on the second end face of the exterior resin. All cathode foils were spaced apart from each other at the second end face. A cathode external electrode was electrically connected to each cathode foil at the second end face. The anode foils and the cathode foils of Comparative Example 1 extend in parallel throughout. That is, in the solid electrolytic capacitor of Comparative Example 1, the first average distance and the second average distance are equal to each other.

### Comparative Example 2

Seven capacitor elements and eight cathode foils were alternately laminated to form a laminate. The laminate was covered with an exterior resin. A part of each anode foil was exposed on the first end face of the exterior resin. All the anode foils were spaced apart from each other at the first end face. An anode external electrode was electrically connected to each anode foil at the first end face. A part of each cathode foil was exposed on the second end face of the exterior resin. At the second end face, all cathode foils were brought into contact with each other on the side opposite the mounting surface. A cathode external electrode was electrically connected to each cathode foil at the second end face. The first average distance along the second end face was set to 167% of the second average distance in the overlap region. The ESR of the solid electrolytic capacitor of Comparative Example 2 was 152% of the ESR of the solid electrolytic capacitor of Comparative Example 1.

As described above, the ESR of each of the solid electrolytic capacitors of Examples 1 and 2 was lower than those of the solid electrolytic capacitors of Comparative Examples 1 and 2. Accordingly, it can be said that the superiority of Examples has been shown.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

The present disclosure can be used in solid electrolytic capacitors and solid electrolytic capacitor production methods.

### REFERENCE NUMERALS

10: Solid electrolytic capacitor
   20: Laminate
      21: Capacitor element
         22: Anode foil
         23: Dielectric layer
         24: Solid electrolyte layer
         25: Conductive layer
      26: Cathode foil
   30: Exterior resin
      31: First end face
      32: Second end face
      33: Mounting surface
   40: Anode external electrode
      41: First portion
      42: Second portion
   50: Cathode external electrode
      51: Third portion
      52: Fourth portion
   60: Conductive adhesive
AD1: First average distance
AD2: Second average distance
D11 to D14: Shortest distances from first end point to respective cathode foils on second end face
D21 to D24: Shortest distances from first end point to respective cathode foils in overlap region
LD: Lamination direction
P1: First end point
R1: Overlap region

What is claimed is:

1. A solid electrolytic capacitor comprising:
a laminate in which a plurality of capacitor elements each including an anode foil, and a plurality of cathode foils are laminated;
an exterior resin that covers the laminate and that has a first end face on which a part of each of the cathode foils is exposed and a second end face on which a part of each of the anode foils is exposed;
an anode external electrode electrically connected to each of the anode foils at the first end face; and
a cathode external electrode electrically connected to each of the cathode foils at the second end face,
wherein a first average distance of the laminate from an end point to the respective the cathode foils in a lamination direction on the second end face on a side of a mounting surface of the exterior resin is smaller than a second average distance from the end point to the respective cathode foils in the lamination direction in a region where the capacitor elements and the cathode foil overlap.

2. The solid electrolytic capacitor according to claim 1,
wherein of the cathode foils, at least cathode foils in one pair are present at the second end face, the at least cathode foils in the one pair being adjacent to and spaced apart from each other in the lamination direction.

3. The solid electrolytic capacitor according to claim 1,
wherein of the anode foils, at least anode foils in one pair are present at the first end face, the at least anode foils in the one pair being adjacent to and spaced apart from each other in the lamination direction.

4. The solid electrolytic capacitor according to claim 1,
wherein the exterior resin contains a filler, and
a content of the filler in the exterior resin is 85 wt% or more and 95 wt% or less.

5. The solid electrolytic capacitor according to claim 1,
wherein a flexural modulus of the exterior resin at 25° C. is 20 GPa or more.

6. The solid electrolytic capacitor according to claim 1,
wherein a glass transition temperature of the exterior resin is 135° C. or higher.

7. A solid electrolytic capacitor production method for producing the solid electrolytic capacitor according to claim 1, comprising:
a preparation step of preparing the laminate; and
a forming step of forming the exterior resin by a compression molding method in which a resin material is supplied to the laminate from a side opposite the mounting surface.

8. The solid electrolytic capacitor production method according to claim 7,
wherein the exterior resin contains a filler, and
a content of the filler in the exterior resin is 85 wt% or more and 95 wt% or less.

9. The solid electrolytic capacitor production method according to claim 7,
wherein a flexural modulus of the exterior resin at 25° C. is 20 GPa or more.

10. The solid electrolytic capacitor production method according to claim 7,
wherein a glass transition temperature of the exterior resin is 135° C. or higher.
